(19) United States
(12) Patent Application Publication
(10) Pub. No.: US 2007/0020488 A1
(43) Pub. Date: Jan. 25, 2007

(54) Magnetic recording medium having a single, thin, high-coercivity magnetic recording layer

(75) Inventors: Ramnath Subramaniam, Woodbury, MN (US); Meng C. Hsieh, Woodbury, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/185,267

(22) Filed: Jul. 19, 2005

(51) Int. Cl. G11B 5/708

(52) U.S. Cl. 428/842

(57) ABSTRACT

A magnetic recording medium comprising a non-magnetic substrate having a front side and a backside, said front side having disposed thereon only one coating, said coating consisting essentially of a thin magnetic recording layer comprising magnetic pigment particles, and a binder system for said pigment particles, said single thin magnetic coating layer having a minimum coercivity of at least about 2000 Oersteds (Oe), and a thickness of not more than about 0.25 μm.

### THE FIELD OF THE INVENTION

The present invention relates generally to magnetic recording tapes, more specifically to single layer, high-density magnetic recording media having very thin coatings.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, such magnetic recording media generally comprise a magnetic layer coated onto at least one side of a non-magnetic substrate (e.g., a film for magnetic recording tape applications). The formulation for the magnetic coating is optimized to maximize the performance of the magnetic recording medium.

As the magnetic recording media have become thinner due to demand for such products, the ferromagnetic recording media developed a dual-layer approach where the front coating is formed as a dual-layer construction, including a support layer (or “lower layer”) on the substrate and a reduced-thickness magnetic layer (or “upper layer”) formed directly on the support or lower layer. With this construction, the lower layer is typically non-magnetic or substantially non-magnetic, generally comprised of a non-magnetic powder and a binder. Conversely, the upper layer comprises a magnetic metal particle powder or pigment dispersed in a polymeric binder.

Magnetic recording media also typically have a backside coating applied to the opposing side of the non-magnetic substrate in order to improve the durability, conductivity, and tracking characteristics of the media.

Particulate based magnetic recording media include a granular pigment in the magnetic layer of the frontside coating. Popular pigments are metal oxides, ferromagnetic metal oxides, and ferromagnetic metal alloys. Different pigments have different surface properties, the metal particles often have a strongly basic surface. Recording media often utilize iron oxide particles in their formulations such as alpha hematite (α-Fe₂O₃), gamma iron oxide (γ-Fe₂O₃), magnetite (Fe₃O₄), cobalt-doped iron oxides, or ferromagnetic metal or metal alloy powders, along with carbon black particles.

All front coatings or layers of magnetic recording media generally include a binder composition. The binder composition performs such functions as dispersing the particulate materials, increasing adhesion between layers and to the substrate, improving gloss and the like. As might be expected, the formulation specifics as well as coating of the binder compositions to an appropriate substrate are highly complex, and vary from manufacturer to manufacturer; however, most binders include such materials as thermoplastic resins.

While the dual-layer approach has been both useful and successful, it also has some drawbacks. For example, the dual layers take up more space when wound onto the cog or wheel of a cartridge, and thereby limit the capacity of the cartridge. However, these drawbacks have been tolerated due to the dramatically thinner magnetic layer, which has typically not been able to be used alone. It would be desirable to provide a single layer magnetic recording medium which would employ the thinner magnetic layer in a single layer embodiment and have the necessary high recording density for use in current products, while providing attendant increased capacity. Previous single layer recording media had lower densities and higher surface roughness than dual-layer magnetic recording media were able to provide. Further, single magnetic layers without support layers have been required to be at least about 0.76 micron (μm).

It has now been discovered that a high density single layer magnetic recording medium may be formed having a heretofore unachievable thinness for a magnetic recording layer in a single layer embodiment. Such magnetic recording media also employs a magnetic pigment having a high coercivity.

### SUMMARY OF THE INVENTION

The invention provides a magnetic recording medium including a non-magnetic substrate, having a single magnetic coating on the front side of the substrate. The magnetic layer contains a primary metallic particulate pigments, and a binder system therefor.

Specifically, the invention provides a magnetic recording medium comprising a non-magnetic substrate having a front side and a backside, where the frontside has disposed thereon only one coating which consists essentially of a thin magnetic recording layer comprising magnetic pigment particles, and a binder system for the pigment particles. The single thin magnetic coating layer has a minimum coercivity of at least about 2000 Oersteds (Oe), and a thickness of not more than about 0.25 μm.

In one embodiment, the magnetic recording medium of the invention comprises a non-magnetic substrate having a front side and a backside, including only a single coating. The coating consists essentially of a magnetic layer formed on the front side of the substrate comprising magnetic pigment particles, and a binder system therefor; said pigment particles having a minimum coercivity of at least about 2300 Oersteds (Oe), wherein the magnetic recording layer having a thickness of from about 0.025 μm to about 0.25 μm.

In another embodiment, the invention provides a magnetic recording tape having longitudinal tracks comprising a non-magnetic substrate having a front side and a backside, having only a single magnetic layer formed over the substrate at the front side of the substrate, wherein the single magnetic layer comprising magnetic pigment particles, and a binder system therefor, wherein the pigment particles having a minimum coercivity of at least about 2000 Oersteds (Oe), and the magnetic layer has a thickness of not more than about 0.25 μm.

In one embodiment, the magnetic recording layer is coated onto a primed substrate.

1. The term “coating composition” means a composition suitable for coating onto a substrate.

2. The terms “layer” and “coating” are used interchangeably to refer to a coated composition for a magnetic layer or a support layer. Such layers typically include at least one particulate pigment.

3. The terms “back coating” and “backside coating” are synonymous and refer to a coating on the opposing side of the substrate from a magnetic layer.

4. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.

6. The term “coercivity” means the intensity of the magnetic field needed to reduce the magnetization of a ferromagnetic material to zero after it has reached saturation, taken at a saturation field strength of 10,000 Oersteds.

7. The term “Oersted”, abbreviated as Oe, refers to a unit of magnetic field in a dielectric material equal to 1/μ Gauss, where μ is the magnetic permeability.

8. The term “Wyko Ra” refers to the average roughness of a coating, measured using a laser interferometer from Veeco Instruments, Inc.

9. The term “linear tape open” means a linear tape; the open refers to format and means that a variety of formats produced by different vendors may be available.

10. The term “linear tracks” refers to the individual tracks organized in a linear fashion for deposition of data. Data tracks are organized into data bands and regions.

All weights, amounts and ratios herein are by weight, unless otherwise specifically noted.

### DETAILED DESCRIPTION OF THE PREFERRED EMBODIMENTS

The following detailed description describes certain embodiments and is not to be taken in a limiting sense. The scope of the present invention is defined by the appended claims.

The magnetic recording medium includes a non-magnetic substrate and a single magnetic layer on the front side of the substrate. The various components are described in greater detail below. In general terms, however, the single magnetic layer includes a primary magnetic metal pigment, and a binder for the pigment.

The Magnetic Recording Medium

The magnetic recording medium of the invention may be any medium known in the art for recording of information, audio or video signals.

In one embodiment, the magnetic recording medium of the invention is a linear magnetic recording tape; that is, a magnetic recording tape having longitudinal tracks, including Linear Tape Open specifications according to ECMA International Standards. Such tracks have a width of no greater than about 12 μm (Genl), and a recording density of at least about 92 kFCI.

The Magnetic Recording Layer

In accordance with the current invention, the magnetic recording layer is a very thin layer, being preferably from about 1 micro-inch (0.025 μm) to about 10 micro-inches (0.25 μm) in thickness, preferably from about 1 micro-inch to about 4 micro-inches. In one embodiment, the magnetic recording medium is a magnetic recording tape including a magnetic recording layer having a thickness of not more than about 0.25 μm. In another embodiment, the magnetic recording medium is a magnetic recording tape including a magnetic recording layer having a thickness of not more than about 0.20 μm. In one embodiment, the magnetic recording medium is a magnetic recording tape including a magnetic recording layer having a thickness of not more than about 0.15 μm.

The magnetic particle pigments have a composition including, but not limited to, metallic iron and/or alloys of iron with cobalt and/or nickel, and magnetic or non-magnetic oxides of iron, other elements, or mixtures thereof. Powders having significant iron nitride content are also useful. The magnetic pigment particles may include oxidized passivation shells. Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length of at most about 75 nanometers (nm). In one embodiment, the preferred pigments have an average particle length of at most about 50 nm. Such pigments are readily commercially available from companies such as Toda Kogyo and Dowa Mining Company. Pigments useful in magnetic recording media of the invention have a minimum coercivity of at least about 2000 Oe, preferably at least about 2300 Oe. In one embodiment, the magnetic particle has a coercivity of at least about 2500 Oe.

In addition to the preferred primary magnetic metal particle pigment described above, the magnetic layer further includes soft spherical particles. Most commonly these particles are comprised of carbon black. A small amount, preferably less than about 3%, of at least one large particle carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the layer are small carbon particles, i.e., the particles have a particle size on the order of less than 100 nm, preferably less than about 50 nm.

The binder system associated with the magnetic layer preferably incorporates at least one binder resin, such as a thermoplastic resin, in conjunction with other resin components such as binders and surfactants used to disperse the head cleaning agent (HCA), a surfactant (or wetting agent), and one or more hardeners.

In one embodiment, the magnetic layer comprises a binder system including both a polyurethane resin and a vinyl resin. The vinyl resin may be a vinyl chloride resin or a non-halogenated vinyl resin. Examples of useful polyurethanes include polyether-polyurethane, polyester-polyurethane, polycarbonate-polyurethane, polyester-polycarbonate-polyurethane, and polycaprolactone-polyurethane. Non-halogenated vinyl resins containing styrene and acrylonitrile monomers can also be employed with the polyurethane binder, if desired.

In one preferred embodiment, the polyurethane binder is incorporated into the magnetic layer in an amount of from about 2 to about 10 parts by weight, and preferably from about 4 to about 8 parts by weight, based on 100 parts by weight of the primary magnetic layer pigment, and the vinyl binder is incorporated in an amount of from about 8 to about 16 parts by weight, and preferably from about 11 to about 13 parts by weight, based on 100 parts by weight of the magnetic layer pigment.

The magnetic layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The binder system further preferably includes an HCA binder used to disperse the selected HCA material, such as a vinyl binder (in conjunction with a pre-dispersed or paste HCA). Alternatively, other HCA binders compatible with the selected HCA format (e.g., powder HCA) are acceptable. As with other ingredients, HCA may be added to the main dispersion separately or dispersed in the binder system, and then added to the main dispersion.

The magnetic layer may further contain one or more lubricants such as a fatty acid and/or a fatty acid ester. The incorporated lubricant(s) exist throughout the front coating and, importantly, at the surface thereof the magnetic layer. The lubricant(s) reduces friction to maintain smooth contact with low drag, and protects the media surface from wear. The lubricant is typically distributed throughout the magnetic layer; however, it may migrate to the surface or be topically applied to the surface of the magnetic recording layer. Lubricants existing on the surface of the magnetic recording layer do not constitute another “layer” of the magnetic recording medium.

Preferred fatty acid lubricants include at least 90 percent pure stearic acid. Although technical grade acids and/or acid esters can also be employed for the lubricant component, incorporation of high purity lubricant materials ensures robust performance of the resultant medium. Other acceptable fatty acids include one or more of myristic acid, palmitic acid, oleic acid, etc., and their mixtures. The magnetic layer formulation can further include one or more fatty acid esters such as butyl stearate, isopropyl stearate, butyl oleate, butyl palmitate, butyl myristate, hexadecyl stearate, and oleyl oleate.

Previous single layer magnetic recording tapes had durability issues when thin coatings were attempted. However, it is believed that selecting the appropriate magnetic pigments and lubricant, and by properly affixing the lubricant on the surface, thin single layer tapes of the invention will meet durability requirements of the industry.

In a preferred embodiment, the lubricant is incorporated into the magnetic layer in an amount of from about 1 to about 10 parts by weight, and preferably from about 1 to about 5 parts by weight, based on 100 parts by weight of the primary pigment.

The binder system may also contain a conventional surfactant or wetting agent. Known surfactants, e.g., adducts of sulfuric, sulfonic, phosphoric, phosphonic, and carboxylic acids, are acceptable.

The coating composition may also contain a hardening agent such as isocyanate or polyisocyanate. In a preferred embodiment, the hardener component is incorporated into the magnetic layer in an amount of from about 1 to about 5 parts by weight, and preferably from about 2 to about 4 parts by weight, based on 100 parts by weight of the primary magnetic pigment.

The materials for the magnetic layer are mixed with the primary pigment and coated atop the substrate. Useful solvents associated with the magnetic layer coating material preferably include cyclohexanone (CHO), with a preferred concentration of from about 5% to about 50%, methyl ethyl ketone (MEK) preferably having a concentration of from about 40% to about 90%, and toluene (Tol), of concentrations from about 0% to about 40%. Alternatively, other ratios can be employed, or even other solvents or solvent combinations including, for example, xylene, methyl isobutyl ketone, tetrahydrofuran, and methyl amyl ketone, are acceptable.

Substrate

The substrate can be any conventional non-magnetic film substrate useful as a magnetic recording tape support. Exemplary substrate materials useful for magnetic recording tapes include polyesters such as polyethylene terephthalate (PET), polyethylene naphthalate (PEN), a mixture of polyethylene terephthalate and polyethylene naphthalate; polyolefins (e.g., polypropylene); cellulose derivatives; polyamides; and polyimides. Thickness of the film may vary from about 120 micro-inches (3 μm) to about 250 micro-inches (about 6.25 μm) in thickness. The substrate may be provided unprimed, as a substrate which has been subjected to a surface treatment such as a corona treatment, or as a primed substrate, where desirable, e.g., to increase the ease of coating of the magnetic recording layer, improve general handling or improve adhesion of the single magnetic layer to the substrate. When primers are employed on the surface of substrates used in magnetic recording media, such primers are not considered additional “coatings” or “layers” of the medium. In magnetic recording media such terms are used to refer to magnetic recording layers and support or sub-layers. For example, “dual-layer” magnetic recording media may include primed substrates while still being considered “dual-layer”.

Back Coat

The back coat, if used, is generally of a type conventionally employed, and thus primarily consists of a soft (i.e., Moh's hardness<5) non-magnetic particle material such as carbon black or silicone dioxide particles. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 25 nm, whereas the secondary, large carbon component preferably has an average particle size on the order of from about 50 to about 300 nm.

As is known in the art, back coat pigments dispersed as inks with appropriate binders, surfactant, ancillary particles, and solvents are typically purchased from a designated supplier. In a preferred embodiment, the back coat binder includes at least one of: a polyurethane resin, a phenoxy resin, or nitrocellulose added in an amount appropriate to modify coating stiffness as desired.

Process for Manufacture

The coating materials of the front layer according to the present invention are prepared by dispersing the corresponding powders or pigments and the binders in a solvent. The primary metal particle powder or pigment materials are placed in a high solids mixing device along with certain of the resins (i.e., polyurethane binder, non-halogenated vinyl binder, and surfactant) and the solvent and processed for from about 1 to about 4 hours. The resulting material is processed in a high-speed impeller dissolver for about 30 to about 90 minutes, along with additional amounts of the solvent. Following this letdown processing, the resulting composition is subjected to a sandmilling or polishing operation. Subsequently, the HCA and related binder components are added, and the composition left standing for about 30 to about 90 minutes. Following this letdown procedure, the composition is processed through a filtration operation, and then stored in a mixing tank at which the hardener component and lubricants are added. The resulting material is then ready for coating onto the substrate.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

75 nm MPs are coated both in a single layer and in a dual layer construction. Table 1 summarizes some of the properties of the tapes. C1 consisting of a magnetic layer and a sublayer is 10 times thicker than that of E1 which only has a magnetic layer (on the front side). The magnetic properties, roughness, and skirt SNR of the two are comparable.

TABLE 1

| | MP | | Thickness | | | | AFM | Skirt |
|---|---|---|---|---|---|---|---|---|
| | Length | Number of | of Top | | | | Ra | SNR |
| | (nm) | Layers | Layers (nm) | Mr * t | Hc (Oe) | Squareness | (nm) | (dB) |
| C1 | 75 | 2 | 1370 | 3.23 | 2610 | 0.93 | 4.8 | 28.1 |
| E1 | 75 | 1 | 130 | 3.6 | 2620 | 0.91 | 4.9 | 28.1 |

Smaller MPs can also be used in a single layer construction. Table 2 shows the some of the results from tapes coated with 60 nm metal pigments. C2 is again much thicker in construction in comparison to E2. The magnetic properties between the two are comparable. The single layer construction may be slightly rougher according to Wyko Ra.

TABLE 2

| | | Number | Thickness of | | | | |
|---|---|---|---|---|---|---|---|
| | MP Length | of | Top Layers | | | | Wyko Ra |
| | (nm) | Layers | (nm) | Mr * t | Hc (Oe) | Squareness | (nm) |
| C2 | 60 | 2 | 1320 | 2.58 | 2779 | 0.92 | 2.1 |
| E2 | 60 | 1 | 100 | 2.84 | 2771 | 0.92 | 3.0 |

1. A magnetic recording medium comprising a non-magnetic substrate selected from the group consisting of polyethylene terephthalate, polyethylene naphthalate, a mixture of polyethylene terephthalate and polyethylene naphthalate; polyolefins; cellulose derivatives; polyamides, and polyimides, said substrate having a front side and a backside, said frontside having deposited directly thereon only one layer, said layer consisting of a thin magnetic recording layer comprising magnetic pigment particles having a particle length of at most about 50 nm, and a binder system for said pigment particles, said single thin magnetic coating layer having a minimum coercivity of at least about 2000 Oersteds (Oe), and a thickness of not more than about 0.25 μm, said magnetic recording layer optionally having lubricant incorporated into said layer and affixed thereto.

2. A magnetic recording medium according to claim 1, wherein said magnetic recording layer comprises magnetic recording particles having a coercivity of at least about 2300 Oe.

3. A magnetic recording medium according to claim 1, wherein said magnetic recording layer comprises magnetic recording particles having a coercivity of at least about 2500 Oe.

4. A magnetic recording medium according to claim 1, wherein said magnetic recording layer has a thickness of from about 0.025 μm to about 0.25 μm.

5. A magnetic recording medium according to claim 1, wherein said magnetic recording layer has a thickness of from about 0.025 μm to about 0.20 μm.

6. A magnetic recording medium according to claim 1, wherein said magnetic recording layer has a thickness of from about 0.025 μm to about 0.15 μm.

7. (canceled)

8. A magnetic recording medium according to claim 1, wherein the magnetic layer comprises a primary ferromagnetic pigment, aluminum oxide, a spherical large particle carbon material, a polyurethane binder, a vinyl binder, a hardener, a fatty acid ester lubricant, and a fatty acid lubricant.

9. A magnetic recording medium according to claim 1, further comprising a coating on said backside of said substrate.

10. A magnetic recording medium according to claim 1, wherein said substrate is a primed substrate.

11. A magnetic recording tape comprising a non-magnetic substrate selected from the group consisting of polyethylene terephthalate, polyethylene naphthalate, a mixture of polyethylene terephthalate and polyethylene naphthalate; polyolefins; cellulose derivatives; polyamides, and polyimides, said substrate having a front side and a backside, said frontside having deposited directly thereon only one layer, said consisting of a single magnetic layer comprising magnetic pigment particles having a particle length of at most about 50 nm, and a binder system therefor, said pigment particles having a minimum coercivity of at least about 2000 Oersteds (Oe), said magnetic recording layer having a thickness of not more than about 0.25 μm, said magnetic recording layer optionally having lubricant incorporated into said layer and affixed thereto.

12. A magnetic recording tape according to claim 11, wherein said magnetic recording medium has a coercivity of at least about 2300 Oe.

13. A magnetic recording tape according to claim 11, wherein said magnetic recording layer has a thickness of from about 0.025 μm. to about 0.20 μm.

14. A magnetic recording tape according to claim 11, wherein said magnetic recording layer has a thickness of from about 0.025 μm to about 0.15 μm.

15. A magnetic recording tape according to claim 14, wherein said tape is a linear tape.

16. A magnetic recording tape according to claim 15, wherein said tapes have longitudinal tracks having a width of no more than about 12 μm.

17. (canceled)

18. A magnetic recording tape according to claim 11, wherein the magnetic layer comprises a primary ferromagnetic pigment, aluminum oxide, a spherical large particle carbon material having an average particle size of from about 50 to about 500 nm, a polyurethane binder, a polyvinylchloride binder, a hardener, a fatty acid ester lubricant, and a fatty acid lubricant.

19. A magnetic recording tape according to claim 11, further comprising a coating on said backside of said substrate.

20. A magnetic recording tape according to claim 11, wherein said substrate is a primed substrate.
